(19) United States
(12) Patent Application Publication
(10) Pub. No.: US 2009/0114296 A1
(43) Pub. Date: May 7, 2009

(54) VALVE ELEMENT, VALVE, SELECTOR VALVE, AND TRAP DEVICE

(75) Inventor: Einosuke Tsuda, Yamanashi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Tokyo Electron Limited, Minato-ku (JP)

(21) Appl. No.: 11/917,030

(22) PCT Filed: Jun. 8, 2006
(86) PCT No.: PCT/JP2006/311518

§ 371 Date: Dec. 10, 2007

(30) Foreign Application Priority Data
Jun. 10, 2005 (JP) 2005-171245

(51) Int. Cl. F16K 5/00; E03B 1/00

(52) U.S. Cl. 137/613; 251/304

(57) ABSTRACT

When supplying a fluid to a first flow channel (11a) of a valve (1), air is introduced into an air cylinder (3a) from an air introduction channel (35a). An operating plate (5a) thus slides and drives a shaft (4a) to move backward to such a position that a second sealing surface (8a) of a sealing plate (6a) abuts against a wall (13a). An air cylinder (3b) is moved forward to such a position that a sealing surface (7b) of a sealing plate (6b) abuts against a wall (12b), thereby sealing an opening (14b).

### TECHNICAL FIELD

The present invention relates to a valve element, a valve, a switching valve, and a trap device and, more particularly, to a valve element, a valve, a switching valve, and a trap device comprising the switching valve, which are suitably used in a discharge channel through which an exhaust gas is discharged from, e.g., a vacuum apparatus.

### BACKGROUND ART

In manufacturing a device such as an electronic component, a substrate such as a semiconductor wafer or a glass substrate undergoes various types of processes such as film formation or etching in a process chamber such as a vacuum chamber. In this process, the process chamber is connected to an exhaust channel, and exhaust is performed through the exhaust channel. An unreacted process gas, a reaction product, and the like mixing in the exhaust gas include a toxic substance and a recyclable substance. Accordingly, a trap device is provided for trapping the toxic substance and recyclable substance so they will not be released into the atmosphere.

the atmosphere.

As the trap device, a switching type trap device is proposed (for example, see Patent Document 1) which comprises two trap chambers and a double acting cylinder mechanism for performing switching between the two trap chambers and connecting the selected trap chamber to an exhaust channel. While the reaction product and the like in the exhaust gas are trapped in one trap chamber connected to the exhaust channel, the other trap chamber can be cleaned for the purpose of refreshing.

Patent Document 1: Jpn. Pat. Appln. KOKAI Publication No. 2004-111834 (FIG. 1 and the like)

### DISCLOSURE OF INVENTION

Where supplying two or more types of fluids such as gases that cannot mix with each other, the mechanism employed is not limited to a switching type trap mechanism. To switch flow channels by using a valve mechanism, generally, a plurality of valves are provided to prevent the fluids from mixing. Where the plurality of valves are provided, however, the space necessary to set the valves of the switching portions and pipes increases, and the entire device becomes bulky.

In the switching type trap device as in the above patent document 1 (Jpn. Pat. Appln. KOKAI Publication No. 2004-111834), in a state (trapping) in which an exhaust gas is supplied to a trap chamber, the trap chamber is set at a vacuum pressure. In a state (refreshing) in which supply of the exhaust gas is stopped and a cleaning liquid such as water is introduced to the trap chamber to clean the trap chamber, the trap chamber is set at a normal pressure. The switching type trap device in which a vacuum-state trap chamber and a normal-pressure trap chamber are adjacent in this manner needs to employ a reliable seal structure that can withstand the pressure difference between the vacuum and normal pressures.

For this reason, in the switching type trap device of the above patent document 1, an O-ring is interposed between a partition and the flange of a cylinder connected to the piston of the cylinder mechanism. The flange and partition are set close to each other to maintain the sealing properties. This structure simplifies the seal structure and improves the sealing response, thus realizing a highly reliable switching mechanism. Although the switching mechanism of patent document 1 is excellent in the sealing properties and sealing response in this manner, it has difficulty in checking whether the seal portion is reliably sealed. troubled portion is difficult to identify, and maintenance takes time, leaving room for improvement.

It is, therefore, an object of the present invention to provide a switching mechanism which facilitates checking of the sealing state of a valve element with a simpler mechanism while ensuring high sealing properties.

In order to achieve the above problem, according to a first aspect of the present invention, there is provided a valve element for a valve for opening/closing a fluid flow channel, wherein

the valve element is provided to an end of a shaft which is driven in an axial direction, and

the valve element includes a first sealing surface configured to seal at least one fluid flow channel and a second sealing surface configured to seal a fluid flow channel different from the fluid flow channel, the first sealing surface and the second sealing surface being provided with seal portions, respectively.

The valve element according to the first aspect can be used as an opening/closing valve or a switching valve despite its simple structure.

In the first aspect, the valve element preferably forms a disk, and the first sealing surface is formed on a front surface of the disk and the second sealing surface is formed on a rear surface of the disk. The seal portion preferably includes a double seal structure. This makes it possible to ensure high sealing properties. In this case, the valve element preferably comprises a gas introducing portion through which a gas is introduced to a gap inside the double seal structure in a sealing state, and a measuring mechanism configured to measure one of a flow rate and a pressure of the gas which is to be introduced from the gas introducing portion. This makes it possible to easily monitor the sealing state, thereby realizing a valve mechanism with high reliability. The valve element preferably comprises a temperature control mechanism in the valve element.

According to a second aspect of the present invention, there is provided a valve for opening/closing a fluid flow channel communicating with an in/out-flow portion through an opening formed therein, the in/out-flow portion being configured for a fluid to flow in and out therethrough, the valve comprising

a valve element provided to an end of a shaft which is driven in an axial direction, and including a first sealing surface configured to close the opening so as to seal the fluid flow channel and a second sealing surface configured to seal a fluid flow channel different from the fluid flow channel,

wherein the first sealing surface and the second sealing surface are provided with seal portions, respectively.

In the second aspect, the valve element preferably forms a disk, and the first sealing surface is formed on one surface of the disk and the second sealing surface is formed on a rear surface of the disk. The seal portion preferably includes a double seal structure. In this case, the valve preferably comprises a gas introducing portion through which a gas is introduced to a gap inside the double seal structure in a sealing state, and a measuring mechanism configured to measure one of a flow rate and a pressure of the gas which is to be introduced from the gas introducing portion.

An inner surface of a member which constitutes the fluid flow channel and against which at least the first sealing surface and the second sealing surface abut is preferably coated with a fluoroplastic. This makes it possible to improve the corrosion resistance, to prevent a deposit from being attached, and to prevent a sealing member, such as an O-ring, used for a sealing portion from adhering to a wall surface. The valve preferably comprises a temperature control mechanism in the valve element.

According to a third aspect of the present invention, there is provided a switching valve for switching between at least two fluid flow channels, the switching valve comprising:

an in/out-flow portion through which a fluid flows in or flows out;

a first fluid flow channel configured to communicate with the in/out-flow portion through a first opening formed in the in/out-flow portion; and

a second fluid flow channel configured to communicate with the in/out-flow portion through a second opening formed in the in/out-flow portion,

the switching valve further comprising:

a first valve element configured to close the first opening so as to seal the first fluid flow channel, and

a second valve element configured to close the second opening so as to seal the second fluid flow channel,

wherein the first valve element and the second valve element are provided to ends of shafts which are separately driven in axial directions.

According to the third aspect, fluid flow channels can be switched with high sealing properties by a simple structure. Thus, where flow channel spaces are present adjacent to each other with a valve element interposed therebetween, different gases can be supplied to flow therethrough, and their pressures can be independently set at a vacuum, pressurized, or normal pressure. Accordingly, this switching valve is preferably applied to a trap device provided on the exhaust channel of a vacuum apparatus or exhaust channels for a plurality of types of gases that should not be mixed.

In the third aspect, the first valve element preferably includes a first sealing surface configured to seal the first fluid flow channel and a second sealing surface configured to seal a fluid flow channel different from the first fluid flow channel, the first sealing surface and the second sealing surface being provided with seal portions, respectively. The second valve element preferably includes a first sealing surface configured to seal the second fluid flow channel and a second sealing surface configured to seal a fluid flow channel different from the second fluid flow channel, the first sealing surface and the second sealing surface being provided with seal portions, respectively.

Each of the first valve element and the second valve element preferably forms a disk, and the first sealing surface is formed on one surface of the disk and the second sealing surface is formed on a rear surface of the disk. The seal portion preferably includes a double seal structure. In this case, the switching valve preferably comprises a gas introducing portion through which a gas is introduced to a gap inside the double seal structure in a sealing state, and a measuring mechanism configured to measure one of a flow rate and a pressure of the gas which is to be introduced from the gas introducing portion.

Inner surfaces of members which respectively constitute the first fluid flow channel and the second fluid flow channel and against which at least the first sealing surface and the second sealing surface abut respectively are preferably coated with a fluoroplastic.

The first fluid flow channel and the second fluid flow channel may form part of an exhaust channel through which an exhaust gas from a vacuum process chamber is discharged, and communicate with a trap device configured to trap a substance in the exhaust gas. The switching valve preferably comprises a temperature control mechanism in the first valve element and/or the second valve element.

According to a fourth aspect of the present invention, there is provided a trap device for trapping a substance in an exhaust gas, to be provided midway along an exhaust channel including an in/out-flow portion through which the exhaust gas from a vacuum process chamber flows in and out, a first exhaust gas flow channel being configured to communicate with the in/out-flow portion through a first opening formed in the in/out-flow portion, and a second exhaust gas flow channel being configured to communicate with the in/out-flow portion through a second opening formed in aid in/out-flow portion, the trap device comprising:

a switching mechanism configured to alternately switch inflow of the exhaust gas into a plurality of trap chambers and comprising a switching valve including a first valve element configured to close the first opening so as to seal the first exhaust gas flow channel, and a second valve element configured to close the second opening so as to seal the second exhaust gas flow channel, the first valve element and the second valve element being provided to ends of shafts which are separately driven in axial directions.

In this case, a trapping function and a refreshing function can be switched by a simple switching mechanism while ensuring high sealing properties, thereby providing the trap device with high reliability.

In the fourth aspect, the trap device preferably comprises a temperature control mechanism in the first valve element and the second valve element. The vacuum process chamber may comprise a vacuum chamber for a film deposition apparatus configured to form a film on a target body.

A valve comprising the valve element according to the present invention has a wide application range despite the simple structure and a small installation space, and can be used as an opening/closing valve represented by, e.g., an L-type valve, a switching valve, or the like. The simple structure facilitates trouble identification and maintenance.

If the valve element has a double seal structure, a leak checking gas is introduced to the gap between the seal portions in the sealing state, and gas leak is monitored by flow rate measurement or the like, the valve can be utilized in a variety of applications as a highly reliable valve mechanism with which the sealing properties of the valve element can be grasped easily.

### BRIEF DESCRIPTION OF DRAWINGS

FIG. 1 This is a schematic sectional view of a valve according to an embodiment of the present invention.

FIG. 2 This is a schematic sectional view for explaining a state in which the flow channel of the valve in FIG. 1 is switched.

FIG. 3 This is a perspective view showing the schematic arrangement of a valve element.

FIG. 4 This is an enlarged view showing an N₂ gas introducing structure for leak checking.

FIG. 5 This is a schematic sectional view for explaining a state in which all the flow channels of the valve in FIG. 1 are open.

FIG. 6 This is a schematic sectional view for explaining a state in which all the flow channels of the valve in FIG. 1 are sealed.

FIG. 7 This is a view schematically showing a state in which a trap device is provided to an exhaust system for a vacuum process chamber in a semiconductor manufacturing apparatus.

FIG. 8 This is a schematic view showing the arrangement of the trap device.

FIG. 9 This is a schematic view showing the arrangement of the trap device in a state in which flow channels are switched as opposed to the state in FIG. 8.

FIG. 10 This is a schematic sectional view of a valve according to another embodiment of the present invention.

FIG. 11 This is a schematic sectional view for explaining a state in which the flow channel of the valve in FIG. 10 is switched.

FIG. 12A This is a view for explaining a state in which an exhaust gas is supplied to and trapped in a trap device.

FIG. 12B This is a view for explaining a state in which exhaust gas channels are closed.

FIG. 12C This is a view showing the state of a valve immediately after the start of cleaning the trap device.

FIG. 13A This is a view for explaining a state in which cleaning water overflows to the trap device.

FIG. 13B This is a view for explaining a state in which the trap device undergoes drying with N₂ gas.

FIG. 13C This is a view for explaining a state in which the exhaust gas is supplied to and trapped in the trap device again.

FIG. 14 This is a view showing the position of the liquid level of the cleaning liquid in the valve during overflow cleaning.

### BEST MODE FOR CARRYING OUT THE INVENTION

Preferred embodiments of the present invention will be described with reference to the accompanying drawings.

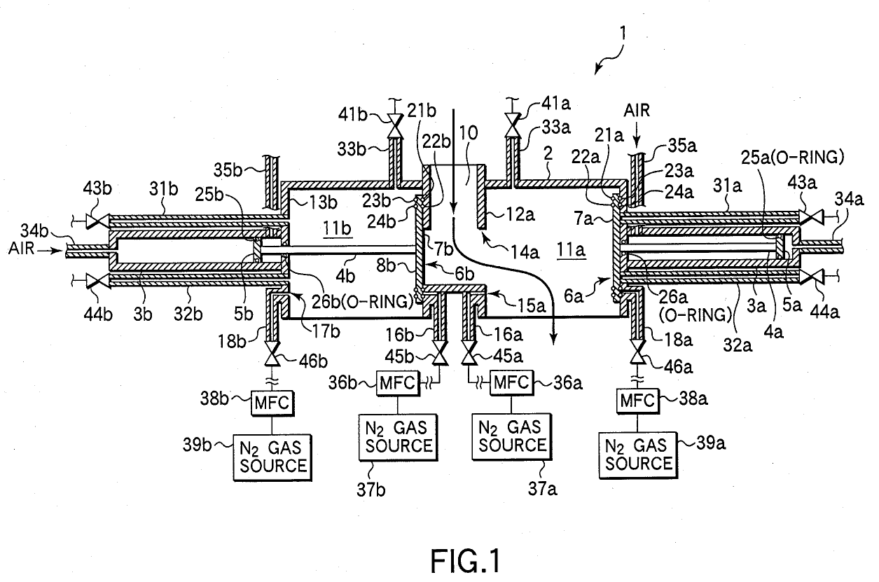

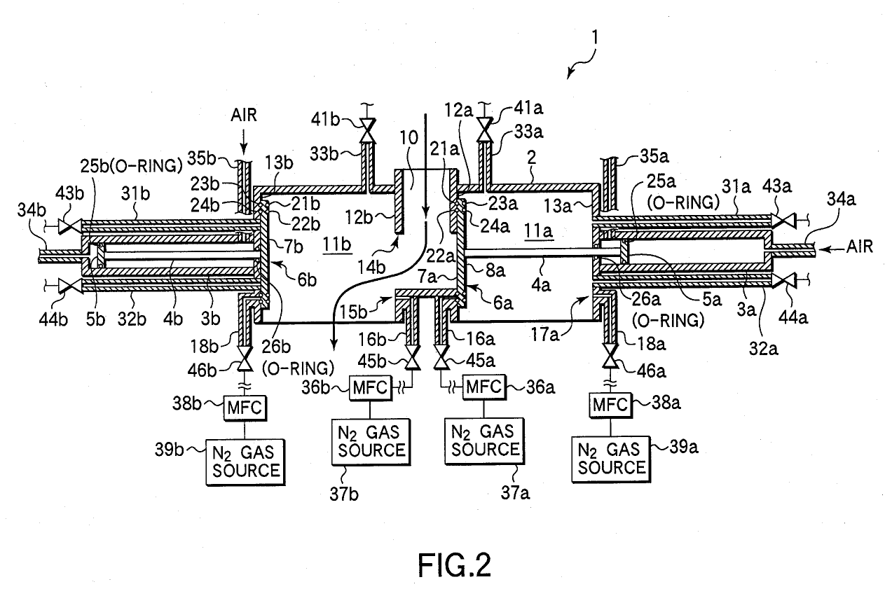

FIGS. 1 and 2 are sectional views showing the schematic arrangement of a valve mechanism according to an embodiment of the present invention. A valve 1 can be suitably used as a switching means or the like for alternately switching the flow channels of an exhaust gas flowing into a trap device for trapping substances in the exhaust gas from, e.g., a vacuum process chamber. The valve 1 is provided with an in-flow portion 10 through which a fluid flows into a housing 2. The valve 1 is almost axis-symmetric about the in-flow portion 10 as the center. More specifically, a first flow channel 11a and a second flow channel 11b are formed in the housing 2 with the in-flow portion 10 in between. A sealing plate 6a serving as a valve element driven by an air cylinder 3a is provided in the first flow channel 11a. A sealing plate 6b serving as a valve element driven by an air cylinder 3b is provided in the second flow channel 11b. Pipe lines 31a, 31b, 32a, 32b, 33a, and 33b are connected to the housing 2 as they extend through the wall of the housing 2.

The in-flow portion 10 communicates with the first flow channel 11a through an opening 14a and with the second flow channel 11b through an opening 14b. The first flow channel 11a communicates with, e.g., a trap chamber (not shown) downstream in the fluid flowing direction. Similarly, the second flow channel 11b communicates with another trap chamber (not shown) downstream in the fluid flowing direction. An arrangement in which the valve 1 is provided adjacent to a trap chamber will be described later.

The inner surface of the housing 2 that constitutes the first flow channel 11a and second flow channel 11b has a coating layer (not shown) formed by coating with a fluoroplastic, e.g., tetrafluoroethylene or perfluoroalkoxy polymer. The fluoroplastic is excellent in heat resistance and corrosion resistance against strong acids, and has a function of preventing a deposit (a reaction product or the like) from being attached. According to this embodiment, coating layers made of the fluoroplastic are respectively formed on the inner surfaces of a wall 12a and a wall 13a against which the sealing plate 6a provided with O-rings 21a to 24a (to be described later) abuts and the inner surfaces of a wall 12b and a wall 13b against which the sealing plate 6b provided with O-rings 21b to 24b abuts, so the O-rings can be prevented from adhering to the corresponding walls. This can ensure the sealing properties of the O-rings, and can decrease the replacement frequency of the O-rings as expendables and the downtimes of the apparatus required for maintenance.

In place of forming the coating layers made of the fluoroplastic, a metal material as the base material of the housing 2 which forms the first flow channel 11a and the second flow channel 11b may be impregnated with the fluoroplastic. Impregnation can also similarly provide effects such as improvement of the corrosion resistance, prevention of deposit attaching, prevention of O-ring adhesion, and the like.

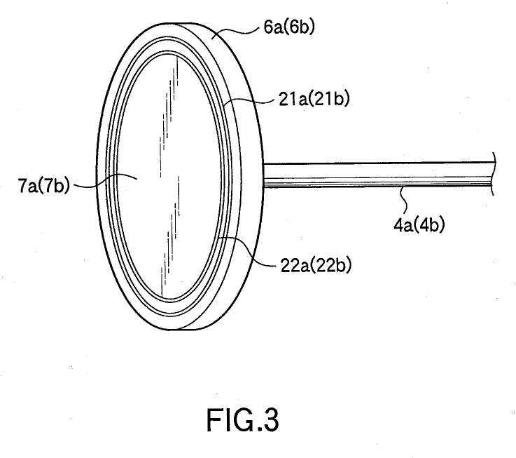

As shown in FIG. 3, the sealing plate 6a is a disk-like valve element and formed at the end of a shaft 4a. The sealing plate 6a has a first sealing surface 7a and a second sealing surface 8a (the side connected to the shaft 4a) behind the first sealing surface 7a. The two O-rings 21a and 22a serving as seal members are disposed on the first sealing surface 7a to ensure high sealing properties when they abut against the wall 12a. Similarly, the two O-rings 23a and 24a are disposed on the second sealing surface 8a to ensure high sealing properties when they abut against the wall 13a.

An operating plate 5a is provided to the end of the shaft 4a on the opposite side to the sealing plate 6a. The operating plate 5a is slidably in tight contact with the inner wall surface of the air cylinder 3a through an O-ring 25a. When introducing air to the space in the air cylinder 3a through an air introduction channel 34a or 35a, the operating plate 5a slides, so the shaft 4a is driven in its axial direction. Thus, the sealing plate 6a can linearly move forward/backward in the first flow channel 11a. An O-ring 26a is interposed between the wall 13a and the shaft 4a which drives in the axial direction to ensure the sealing properties.

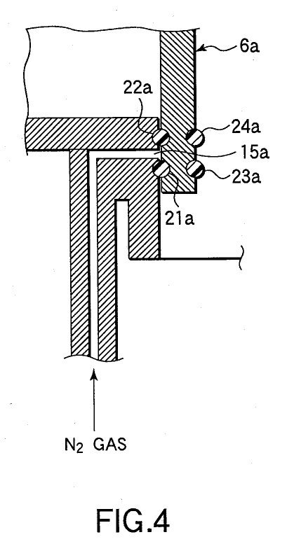

The wall 12a of the first flow channel 11a has an N₂ gas inlet port 15a through which N₂ gas as a purge gas is introduced. The N₂ gas inlet port 15a is connected to a mass flow controller (MFC) 36a serving as a flow rate control means and an N₂ gas source 37a through an N₂ introduction pipe 16a. In place of the mass flow controller (MFC) 36a, a mass flow meter (MFM) may be used (similar replacement is possible in the following description as well). The N₂ gas inlet port 15a is formed at such a position that the N₂ gas can be introduced to the space between the O-rings 21a and 22a when the first sealing surface 7a of the sealing plate 6a abuts against the wall 12a and seals the opening 14a. FIG. 4 shows the structure of the N₂ gas inlet port 15a and its periphery in enlargement. Other N₂ gas inlet ports 15b, 17a, 17b, and the like to be described later have the same structure.

The mass flow controller 36a has a sensor portion (not shown) for monitoring the flow rate of the N₂ gas.

The wall 13a of the first flow channel 11a has an N₂ gas inlet port 17a through which the N₂ gas as the purge gas is introduced. The N₂ gas inlet port 17a is connected to a mass flow controller (MFC) 38a serving as a flow rate control means and an N₂ gas source 39a through an N₂ introduction pipe 18a. The N₂ gas inlet port 17a is formed at such a position that the N₂ gas can be introduced to the portion between the O-rings 23a and 24a when the second sealing surface 8a of the sealing plate 6a abuts against the wall 13a and seals the pipe lines 31a and 32a.

The mass flow controller 38a has a sensor portion (not shown) for monitoring the flow rate of the N₂ gas.

The pipe line 31a is, e.g., a pipe for evacuating (or pressurizing) the interior of the first flow channel 11a. The pipe line 31a is connected to a pump (not shown) through a valve 43a.

The pipe line 32a is, e.g., an introduction pipe for introducing the purge gas or a cleaning liquid for cleaning a trap chamber (not shown) communicating with the first flow channel 11a. The pipe line 32a is connected to a cleaning liquid source and/or a purge gas source (not shown) through a valve 44a.

The pipe line 33a is a discharge pipe which functions as a discharge port for discharging the cleaning liquid or purge gas. The pipe line 33a is connected to a discharge liquid tank and/or an exhaust gas tank (not shown) through a valve 41a.

The sealing plate 6b is a disk-like valve element having the same structure as that of the sealing plate 6a and formed at the end of a shaft 4b. The sealing plate 6b has a first sealing surface 7b and a second sealing surface 8b (the side connected to the shaft 4b) behind the first sealing surface 7b. The two O-rings 21b and 22b serving as seal members are disposed on the first sealing surface 7b to ensure high sealing properties when they abut against the wall 12b. Similarly, the two O-rings 23b and 24b are disposed on the second sealing surface 8b to ensure high sealing properties when they abut against the wall 13b.

An operating plate 5b is provided to the end of the shaft 4b on the opposite side to the sealing plate 6b. The operating plate 5b is slidably in tight contact with the inner wall surface of the air cylinder 3b through an O-ring 25b. When introducing air to the space in the air cylinder 3b through an air introduction channel 34b or 35b, the operating plate 5b slides, so the shaft 4b is driven in its axial direction. Thus, the sealing plate 6b can linearly move forward/backward in the second flow channel 11b. An O-ring 26b is interposed between the wall 13b and the shaft 4b which drives in the axial direction, to ensure the sealing properties.

The wall 12b of the second flow channel 11b has an N₂ gas inlet port 15a through which N₂ gas as the purge gas is introduced. The N₂ gas inlet port 15b is connected to a mass flow controller (MFC) 36b serving as a flow rate control means and an N₂ gas source 37b through an N₂ introduction pipe 16b. The N₂ gas inlet port 15b is formed at such a position that the N₂ gas can be introduced to the portion between the O-rings 21b and 22b when the sealing plate 6b abuts against the wall 12b and seals the opening 14b.

The mass flow controller 36b has a sensor portion (not shown) for monitoring the flow rate of the N₂ gas.

The wall 13b of the second flow channel 11b has an N₂ gas inlet port 17b through which the N₂ gas as the purge gas is introduced. The N₂ gas inlet port 17b is connected to a mass flow controller (MFC) 38b serving as a flow rate control means and an N₂ gas source 39b through an N₂ introduction pipe 18b. The N₂ gas inlet port 17b is formed at such a position that the N₂ gas can be introduced to the portion between the O-rings 23b and 24b when the sealing plate 6b abuts against the wall 13b and seals the pipe lines 31b and 32b.

The mass flow controller 38b has a sensor portion (not shown) for monitoring the flow rate of the N₂ gas.

The pipe line 31b is, e.g., a pipe for evacuating (or pressurizing) the interior of the second flow channel 11b. The pipe line 31b is connected to a pump (not shown) through a valve 43b.

The pipe line 32b is, e.g., an introduction pipe for introducing the purge gas or the cleaning liquid for cleaning a trap chamber (not shown) communicating with the second flow channel 11b. The pipe line 32b is connected to a cleaning liquid source and/or a purge gas source (not shown) through a valve 44b.

The pipe line 33b is a discharge pipe which functions as a discharge port for discharging the cleaning liquid or purge gas. The pipe line 33b is connected to a discharge liquid tank and/or an exhaust gas tank (not shown) through a valve 41b.

In the valve 1 having the above arrangement, when supplying a fluid such as an exhaust gas to the first flow channel 11a, air is introduced into the air cylinder 3a from the air introduction channel 35a, as shown in FIG. 1. Thus, the operating plate 5a slides in the air cylinder 3a and drives the shaft 4a, so the shaft 4a moves backward to such a position that the second sealing surface 8a of the sealing plate 6a abuts against the wall 13a. Also, air is introduced into the air cylinder 3b from the air introduction channel 34b. Thus, the operating plate 5b slides in the air cylinder 3b and drives the shaft 4b, so the shaft 4b moves forward to such a position that the first sealing surface 7b of the sealing plate 6b abuts against the wall 12b, thereby sealing the opening 14b.

In this manner, for example, the exhaust gas can flow in the first flow channel 11a in a vacuum state, while the cleaning liquid can be introduced into the second flow channel 11b at a normal pressure from the pipe line 32b, thus cleaning the second flow channel 11b.

At this time, to check whether the sealing plate 6a is in tight contact with the wall 13a, the N₂ gas is introduced to the portion between the O-rings 23a and 24a from the N₂ gas source 39a through the mass flow controller 38a and N₂ gas inlet port 17a, and the sensor (not shown) of the mass flow controller 38a measures and monitors a change in flow rate of the N₂ gas. If sealing by the sealing plate 6a is incomplete, the gas leaks from the gap between the O-rings 23a and 24a, and the N₂ gas flow rate changes accordingly. Whether the sealing plate 6a seals the pipe lines 31a and 32a reliably can be checked in this manner. Therefore, in the state in FIG. 1, the exhaust gas or a reaction product contained in it can be reliably prevented from mixing in the pipe lines 31a and 32a.

To check whether the sealing plate 6b is in tight contact with the wall 12b, the N₂ gas is introduced to the portion between the O-rings 21b and 22b from the N₂ gas source 37b through the mass flow controller 36b and N₂ gas inlet port 15b, and the sensor (not shown) of the mass flow controller 36b measures and monitors a change in flow rate of the N₂ gas. If sealing by the sealing plate 6b is incomplete, the gas leaks from the gap between the O-rings 21b and 22b, and the N₂ gas flow rate changes accordingly. Whether the sealing plate 6b seals the opening 14b reliably can be checked in this manner.

In place of monitoring the flow rate by the sensor of, e.g., the mass flow controller 38a, the sealing state can be checked by monitoring the pressure of the space between the two O-rings 23a and 24a, or the like (this applies to the case of performing leak check between O-rings at any other portion).

When supplying a fluid such as an exhaust gas to the second flow channel 11b, operation opposite to that described above may be performed. More specifically, as shown in FIG. 2, air is introduced into the air cylinder 3a from the air introduction channel 34a. Thus, the operating plate 5a slides in the air cylinder 3a and drives the shaft 4a, so the shaft 4a moves forward to such a position that the first sealing surface 7a of the sealing plate 6a abuts against the wall 12a.

Air is also introduced into the air cylinder 3b from the air introduction channel 35b. Thus, the operating plate 5b slides in the air cylinder 3b and drives the shaft 4b, so the shaft 4b moves backward to such a position that the second sealing surface 8b of the sealing plate 6b abuts against the wall 13b.

In this manner, for example, the exhaust gas can flow in the second flow channel 11b in a vacuum state, while the cleaning liquid can be introduced into the first flow channel 11a at a normal pressure from the pipe line 32a, thus cleaning the first flow channel 11a.

At this time, to check whether the sealing plate 6a is in tight contact with the wall 12a, the N₂ gas may be introduced to the portion between the O-rings 21a and 22a from the N₂ gas source 37a through the mass flow controller 36a and N₂ gas inlet port 15a, and the sensor (not shown) of the mass flow controller 36a may monitor a change in flow rate of the N₂ gas, in the same manner as described above. Whether the sealing plate 6a seals the opening 14a reliably can be checked in this manner. As described above, in place of monitoring the flow rate by the sensor of the mass flow controller 36a, the sealing state can be checked by monitoring the pressure of the gap between the two O-rings 21a and 22a.

To check whether the sealing plate 6b is in tight contact with the wall 13b, the N₂ gas may be introduced to the portion between the O-rings 23b and 24b from the N₂ gas source 39b through the mass flow controller 38b and N₂ gas inlet port 17b, and the sensor (not shown) of the mass flow controller 38b may monitor a change in flow rate of the N₂ gas. Whether the sealing plate 6b seals the pipe lines 31b and 32b reliably can be checked in this manner.

According to the valve 1 having the above arrangement, the sealing plate 6a formed at the end of the shaft 4a is moved in the first flow channel 11a, and the sealing plate 6b formed at the end of the shaft 4b is moved in the second flow channel 11b independently of the movement of the sealing plate 6a, so the openings 14a and 14b are closed alternatively for switching the flow channels. As the valve 1 has a simple structure as shown in FIG. 1 and so forth, it requires a small space for installation and can be repaired and maintained easily. Introduction of the leak-checking N₂ gas through the N₂ gas inlet ports 15a and 15b and N₂ gas inlet ports 17a and 17b in the sealing state facilitates checking as to whether sealing by the sealing plates 6a and 6b as the valve elements is reliable. Thus, a highly reliable valve mechanism is obtained.

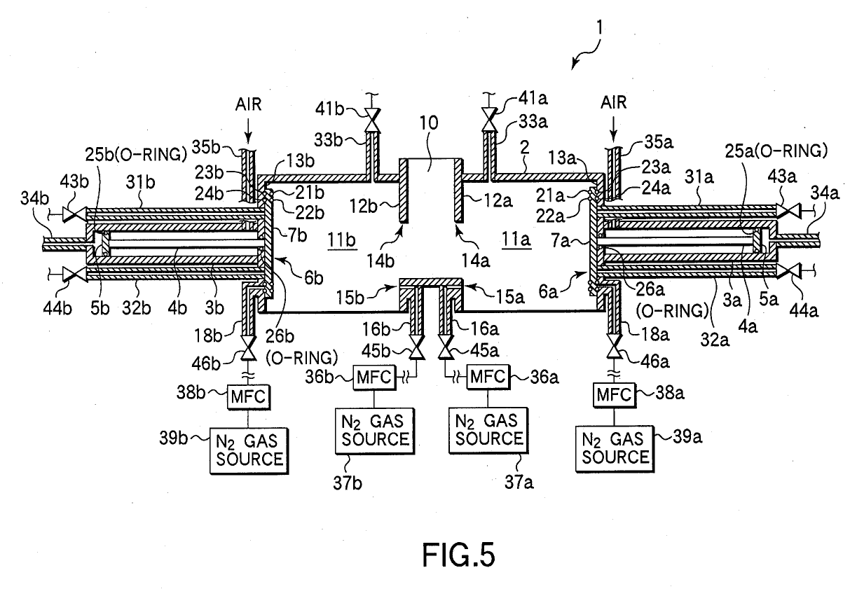

For example, in an arrangement in which the valve 1 is connected to a trap device (to be describe later), assume an urgent case that, e.g., a trouble occurs in either one of two trap chambers respectively connected to the first and second flow channels 11a and 11b during the operation of the trap device. To cope with such a case, as shown in FIG. 5, both the respective shafts 4a and 4b in the first and second flow channels 11a and 11b are retreated to bring the sealing plates 6a and 6b into tight contact with the walls 13a and 13b respectively. This opens the openings 14a and 14b simultaneously, so the exhaust gas can emergently flow to a trap chamber in which no trouble occurs, thus trapping the exhaust gas.

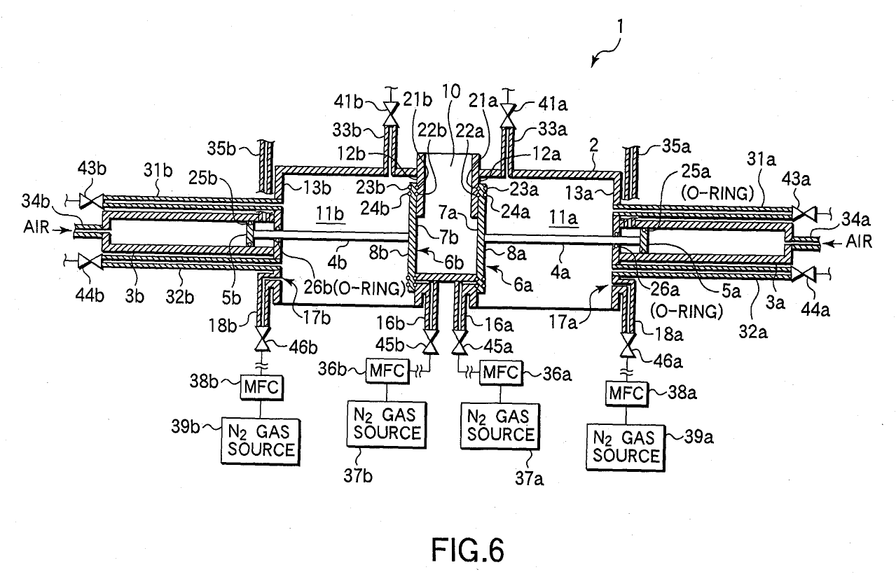

For example, when replacing or maintaining the two trap chambers respectively connected to the first and second flow channels 11a and 11b simultaneously, as shown in FIG. 6, both the shafts 4a and 4b are moved forward into the first and second flow channels 11a and 11b, respectively, so the sealing plates 6a and 6b can seal the openings 14a and 14b simultaneously. In this manner, the valve 1 according to this embodiment has a wide application range and can be used for various purposes.

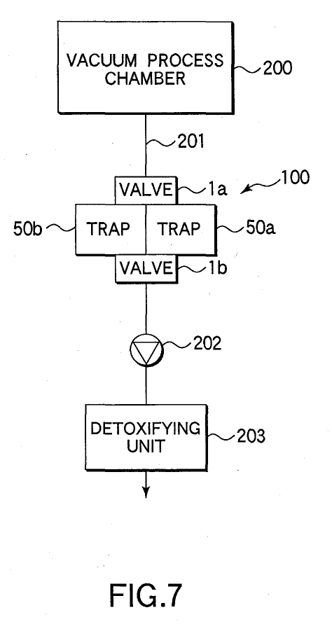

An embodiment in which the valve 1 of FIG. 1 is applied to a trap device will be described with reference to FIGS. 7 to 9.

FIG. 7 schematically shows a state in which a trap device 100 is provided to an exhaust system for a vacuum process chamber 200 in a semiconductor manufacturing apparatus. This trap device 100 is a switching type trap device switchable between a state for trapping an exhaust substance exhausted from the vacuum process chamber 200 and a state for performing a refreshing operation. The trap device 100 is disposed on an exhaust gas channel 201 between the vacuum process chamber 200 of a CVD apparatus or the like and a vacuum pump 202. An exhaust substance such as a toxic substance or a reaction by-product contained in the exhaust gas exhausted from the vacuum process chamber 200 is trapped in trap chambers 50a and 50b. The trap chambers 50a and 50b can be refreshed.

The trap device 100 comprises valves 1a and 1b at its inlet and outlet. The valves 1a and 1b serve as switching means for switching the exhaust gas flow channels. Each of the valves 1a and 1b has almost the same arrangement as that of the valve 1 in FIG. 1. By the operation of the valves 1a and 1b, the trap chambers 50a and 50b are switched to alternately serve as an exhaust gas flow channel. For example, when the trap chamber 50a is to serve as an exhaust gas flow channel, the exhaust gas does not flow to the other trap chamber 50b, but the trap chamber 50b functions as a refreshment chamber for performing a refreshing operation by removing the trapped exhaust substance by gasification, cleaning, or the like. An external processing device (not shown) processes wastewater or the like removed from the trap chamber 50b during the refreshing operation. Referring to FIG. 7, reference numeral 203 denotes a detoxifying device for detoxifying the processed gas supplied from the vacuum pump 202.

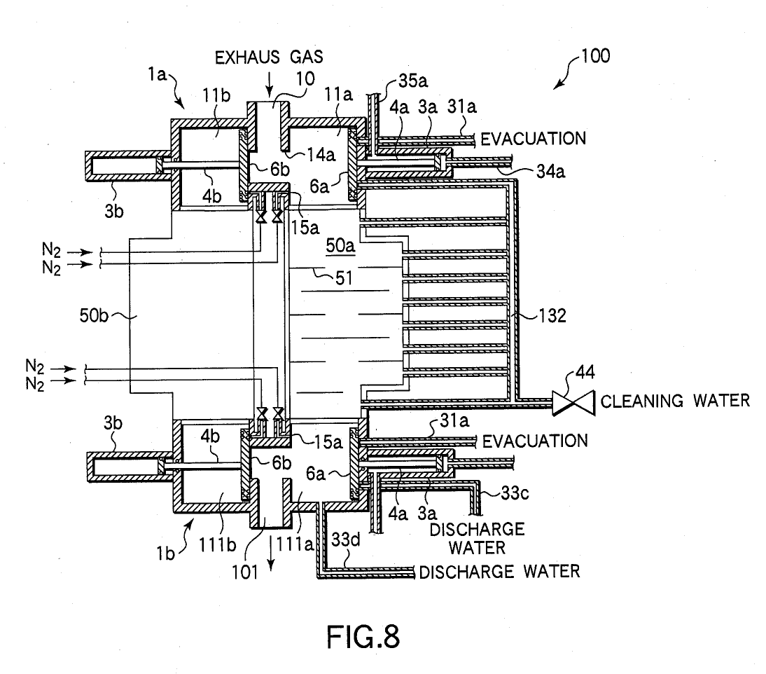

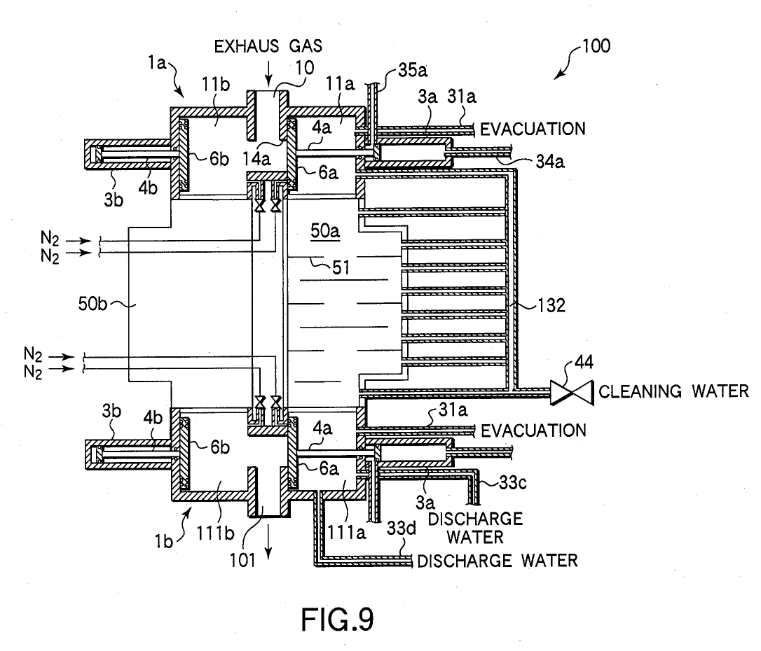

FIGS. 8 and 9 show the schematic arrangement of the trap device 100 comprising the valves 1a and 1b. As the valves 1a and 1b have almost the same arrangement as that of the valve in FIG. 1, the same portions are denoted by the same reference numerals, a description thereof is omitted, and their details are not illustrated. In FIGS. 8 and 9, reference numerals 33c and 33d denote discharge pipes for discharging the cleaning water or the like.

In FIG. 8, a first flow channel 11a of the valve 1a is open, so the exhaust gas flows to the trap chamber 50a.

Each of the trap chambers 50a and 50b incorporates a plurality of baffle plates 51. A resultant complicated flow channel structure traps a toxic substance or a deposit in the exhaust gas. The internal structures of the trap chambers 50a and 50b are not limited to those provided with the baffle plates 51. Alternatively, for example, micromeshes may be disposed in the trap chambers 50a and 50b.

A pipe 132 is used when cleaning the exhaust substance trapped in the trap chamber 50a with cleaning water or the like so as to refresh the trap chamber 50a. Part of the pipe 132 communicates with the first flow channel 11a of the valve 1a as well (see FIG. 1 and the like). Although FIGS. 8 and 9 show the internal structure and the cleaning water introduction pipe 132 of only the trap chamber 50a side, the trap chamber 50b has the same structure.

The valves 1a and 1b are arranged on the inlet ports and outlet ports of the trap chambers 50a and 50b such that they are in opposite directions. Referring to FIG. 8, in the valve 1a arranged at the inlet ports of the trap chambers 50a and 50b, a sealing plate 6a is at a retreat position, and a sealing plate 6b has moved forward into the second flow channel 11b to seal an opening 14b. Only the first flow channel 11a communicates with an in-flow portion 10.

In the valve 1b arranged at the outlet ports of the trap chambers 50a and 50b as well, a sealing plate 6a is at the retreat position, and a sealing plate 6b has moved forward into a second flow channel 111b to seal an opening 14b. Only a first flow channel 111a communicates with an out-flow portion 101. In this manner, the valves 1a and 1b maintain the interior of the trap chamber 50a in a vacuum state, so the trap chamber 50a serves as a trap chamber. The interior of the trap chamber 50b is set in a normal pressure state, so the trap chamber 50b serves as a refreshment chamber.

According to this embodiment as well, N₂ gas may be introduced to the portion between O-rings 23a and 24a or the like from an N₂ gas inlet port 17a or the like, and leak check may be performed, thereby checking the sealing state.

FIG. 9 shows a state in which the second flow channel 11b of the valve 1a is open and the exhaust gas flows to the trap chamber 50b. Referring to FIG. 9, in the valve 1a arranged at the inlet ports of the trap chambers 50a and 50b, the sealing plate 6b is at a retreat position, and the sealing plate 6a has moved forward into the first flow channel 11a to seal an opening 14a. Only the second flow channel 11b communicates with the in-flow portion 10.

In the valve 1b arranged at the outlet ports of the trap chambers 50a and 50b as well, the sealing plate 6b is at the retreat position, and the sealing plate 6a has moved forward into the first flow channel 111a to seal the opening 14a. Only the second flow channel 111b communicates with the out-flow portion 101. In this manner, the valves 1a and 1b maintain the interior of the trap chamber 50b in a vacuum state, so the trap chamber 50b serves as a trap chamber. The interior of the trap chamber 50a is set in a normal pressure state, so the trap chamber 50a serves as a refreshment chamber as cleaning water or the like is introduced into it through the pipe 132.

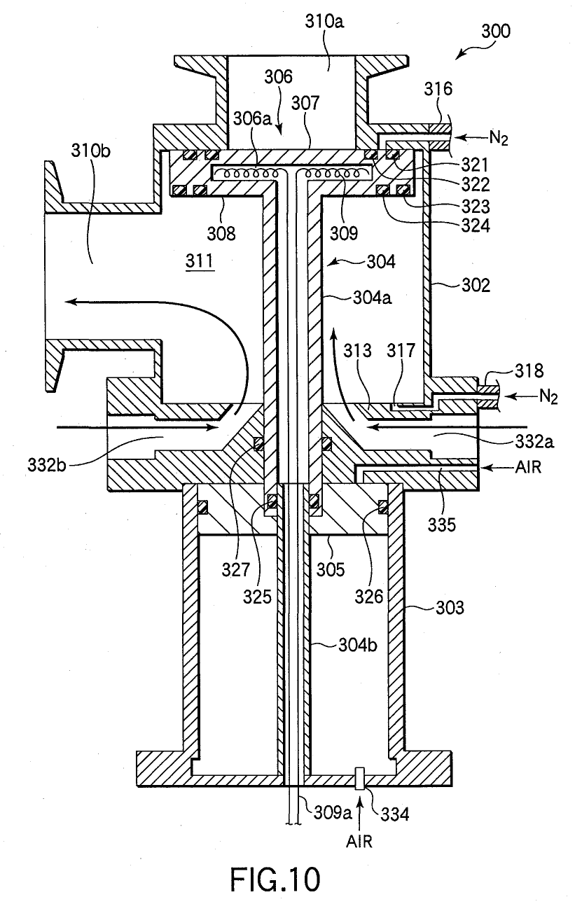

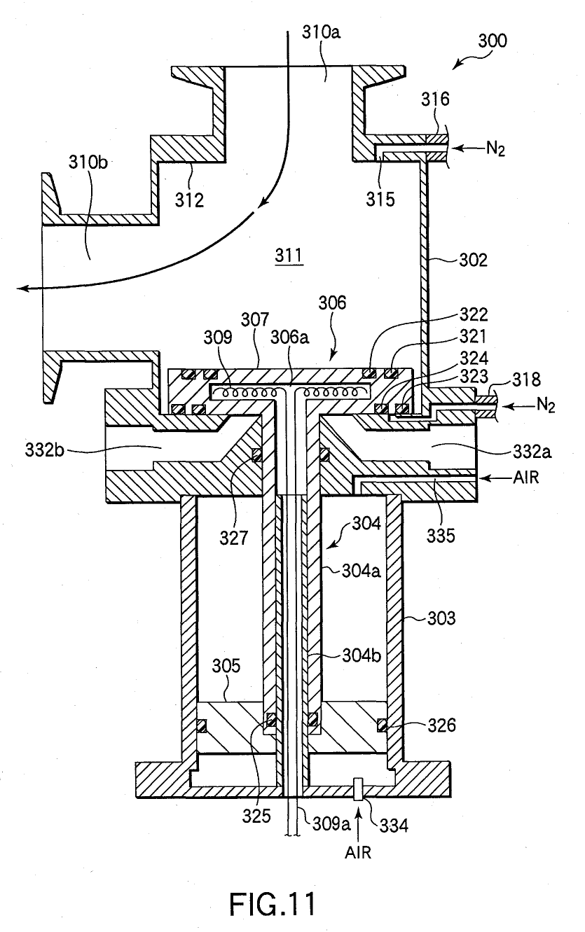

FIGS. 10 and 11 are sectional views showing the schematic arrangement of a valve mechanism according to another embodiment of the present invention. A valve 300 can be suitably used as an L-shaped valve in a flow channel of an exhaust gas flowing into a trap device which traps a substance in the exhaust gas from, e.g., a vacuum process chamber. The valve 300 is provided with in/out-flow portions 310a and 310b, through which a fluid flows in from and out to a housing 302, to be almost perpendicular to each other, thus forming a flow channel 311 which bends in the housing 302. A sealing plate 306 serving as a valve element driven by an air cylinder 303 through a shaft 304 is disposed in the flow channel 311.

The sealing plate 306 is a disk-like valve element (see FIG. 3) and incorporates a hollow portion 306a. The sealing plate 306 has a first sealing surface 307 and a second sealing surface 308 (the side connected to the shaft 304) behind the first sealing surface 307. Two O-rings 321 and 322 serving as seal members are disposed on the first sealing surface 307 to ensure high sealing properties when they abut against a wall 312 of the housing 302. Similarly, two O-rings 323 and 324 are disposed on the second sealing surface 308 to ensure high sealing properties when they abut against a wall 313 of the housing 302.

The shaft 304 arranged perpendicularly to the sealing plate 306 has a hollow double-pipe structure. More specifically, the shaft 304 has an outer cylinder member 304a directly connected to the sealing plate 306 and an inner cylinder member 304b to be inserted in the outer cylinder member 304a. An O-ring 325 serving as a seal member is disposed at the slidable contact portion of the outer cylinder member 304a and inner cylinder member 304b. The interior of the outer cylinder member 304a communicates with the hollow portion 306a in the sealing plate 306. The interior of the inner cylinder member 304b also communicates with the hollow portion 306a of the sealing plate 306 through the interior of the outer cylinder member 304a.

For example, a resistance heater 309 is arranged as temperature control means in the hollow portion 306a of the sealing plate 306. Power is supplied to the resistance heater 309 via a power feed line 309a inserted in the outer cylinder member 304a and inner cylinder member 304b of the shaft 304, so the resistance heater 309 can heat the sealing plate 306 from the inner side. As the temperature control means is arranged in the sealing plate 306 in this manner, it can prevent a by-product in the exhaust gas from being attached to the sealing plate 306. The heating temperature of the sealing plate 306 may suffice if it is high enough to prevent the reaction product (by-product) contained in the exhaust gas from being attached to the sealing plate 306. For example, the valve 300 may be arranged in the exhaust gas flow channel of a CVD apparatus for forming a TiN film on a substrate such as a silicon wafer. In this case, in order to prevent a by-product such as NH₄Cl contained in the exhaust gas from being attached to the sealing plate 306, the heating temperature of the resistance heater 309 to heat the sealing plate 306 is preferably set to, e.g., 150° C. to 200° C.

The temperature control means is not limited to the resistance heater 309. For example, a heating medium such as a gas or a liquid may be introduced into the hollow portion 306a through the inner cylinder member 304b and outer cylinder member 304a and circulated in the hollow portion 306a to heat the sealing plate 306. Temperature control is not limited to heating, but the sealing plate 306 may be cooled by the temperature control means. For example, the valve 300 may be used in the exhaust system of a tungsten film deposition process which employs WF₆ and SiH₄ as deposition gases. In this case, when heating unreacted WF₆ and SiH₄, tungsten is deposited. Therefore, the sealing plate 306 is preferably held at a low temperature. In this case, the sealing plate 306 is preferably cooled by introducing a heating medium such as a low-temperature gas or liquid into, e.g., the hollow portion 306a.

As described above, by using the shaft 304 having the hollow double pipe structure, the sealing plate 306 can be easily adjusted to a predetermined temperature. The shaft 304 need not always have a double structure, but can have a solid rod-like body.

An operating plate 305 is provided to the end of the shaft 304 on the side opposite to the sealing plate 306. The operating plate 305 is slidably in tight contact with the inner wall surface of the air cylinder 303 through an O-ring 326. When introducing air to the space in the air cylinder 303 through an air introduction channel 334 or 335, the operating plate 305 slides, so the shaft 304 is driven in its axial direction. Thus, the sealing plate 306 can linearly move forward/backward in the flow channel 311. An O-ring 327 is interposed between the wall 313 and the shaft 304 which drives in the axial direction, to ensure the sealing properties of this portion.

The wall 312 of the housing 302 has an N₂ gas inlet port 315 through which N₂ gas as the purge gas is introduced. The N₂ gas inlet port 315 is connected to a mass flow controller (MFC) serving as a flow rate control means and an N₂ gas source (neither is shown) through an N₂ introduction pipe 316. The mass flow controller has a sensor portion (not shown) for monitoring the flow rate of the N₂ gas. The N₂ gas inlet port 315 is formed at such a position that the N₂ gas can be introduced to the space between the O-rings 321 and 322 when the first sealing surface 307 of the sealing plate 306 abuts against the wall 312 and seals the in/out-flow portion 310a.

The in/out-flow portion 310a is connected to the vacuum process chamber of, e.g., a CVD apparatus, through a pipe (not shown). The in/out-flow portion 310b communicates with, e.g., a trap chamber (not shown). Accordingly, the flow channel 311 forms part of the flow channel from the vacuum process chamber to the trap chamber (neither is shown). An arrangement in which the valve 300 is provided adjacent to the trap chamber will be described later.

The inner surface of the housing 302 that constitutes the flow channel 311 has a coating layer (not shown) formed by coating with a fluoroplastic, e.g., tetrafluoroethylene or perfluoroalkoxy polymer, in the same manner as the valve 1 of the embodiment shown in FIG. 1. Accordingly, effects such as improvement of the corrosion resistance, prevention of deposit attaching, prevention of O-ring adhesion, and the like can be obtained in the same manner as described above.

The wall 313 of the flow channel 311 has an N₂ gas inlet port 317 through which N₂ gas as the purge gas is introduced. The N₂ gas inlet port 17 is connected to a mass flow controller (MFC) serving as a flow rate control means and an N₂ gas source (not shown) through an N₂ introduction pipe 318. The mass flow controller has a sensor portion (not shown) for monitoring the flow rate of the N₂ gas. The N₂ gas inlet port 317 is formed at such a position that the N₂ gas can be introduced to the portion between the O-rings 323 and 324 when the second sealing surface 308 of the sealing plate 306 abuts against the wall 313 and seals in/out-flow channels 332a and 332b.

Each of the in/out-flow channels 332a and 332b serves as, e.g., an in-flow port when introducing a purge gas or a cleaning liquid for cleaning a trap chamber (not shown) communicating with the flow channel 311, or a discharge port for discharging the purge gas or the cleaning liquid from the trap chamber. The in/out-flow channels 332a and 332b are connected to a cleaning liquid source and/or a purge gas source, or a discharge liquid tank and/or an exhaust gas processing mechanism (none of them is shown).

In the valve 300 having the above arrangement, when supplying a fluid such as an exhaust gas to the flow channel 311, air is introduced into the air cylinder 303 from the air introduction channel 335. Thus, the operating plate 305 slides in the air cylinder 303 and drives the shaft 304, so the shaft 304 moves backward to such a position that the second sealing surface 308 of the sealing plate 306 abuts against the wall 313. In this manner, the exhaust gas can be introduced into the flow channel 311 in a vacuum state from the in/out-flow portion 310a connected to, e.g., a vacuum process chamber (not shown), and can be introduced to, e.g., a trap chamber (not shown) through the in/out-flow portion 310b.

At this time, to check whether the sealing plate 306 is in tight contact with the wall 313, the N₂ gas is introduced to the portion between the O-rings 323 and 324 from an N₂ gas source (not shown) through the N₂ gas inlet port 317, and the sensor (not shown) of the mass flow controller measures and monitors a change in flow rate of the N₂ gas. If sealing by the sealing plate 306 is incomplete, the gas leaks from the gap between the O-rings 323 and 324, and the N₂ gas flow rate changes accordingly. Whether the sealing plate 306 seals the in/out-flow channels 332a and 332b reliably can be checked in this manner. Therefore, in the state of FIG. 11, the exhaust gas or the reaction product contained in it can be prevented from mixing into the in/out-flow channels 332a and 332b.

In place of monitoring the flow rate of the N₂ gas, the sealing state can be checked by monitoring the pressure of the space between the two O-rings 323 and 324 (this applies to the case of performing leak check between O-rings at any other portion).

When supplying a fluid such as a cleaning liquid for cleaning the trap device (not shown), a drying gas, or the like to the flow channel 311, air is introduced into the air cylinder 303 from the air introduction channel 334. Thus, the operating plate 305 slides in the air cylinder 303 and drives the shaft 304, so the shaft 304 moves forward to such a position that the first sealing surface 307 of the sealing plate 306 abuts against the wall 312, as shown in FIG. 10. Thus, for example, a cleaning liquid can be introduced into the flow channel 311 at a normal pressure from the in/out-flow channels 332a and 332b and supplied to the adjacent trap device through the in/out-flow portion 310b, thereby cleaning the interior of the trap device.

At this time, to check whether the sealing plate 306 is in tight contact with the wall 312, the N₂ gas is introduced to the portion between the O-rings 321 and 322 from an N₂ gas source (not shown) through the N₂ gas inlet port 315, and the sensor (not shown) of the mass flow controller monitors a change in flow rate of the N₂ gas, in the same manner as described above. Whether the sealing plate 306 seals the in/out-flow portion 310a to isolate the flow channel 311 and in/out-flow portion 310a from each other reliably can be checked in this manner. As described above, in place of monitoring the flow rate of the N₂ gas, the sealing state may be checked by monitoring the pressure of the gap between the O-rings 321 and 322.

According to the valve 300 having the above arrangement, the flow channel can be switched between the in/out-flow portion 310a, and the in/out-flow channels 332a and 332b by moving forward/backward the sealing plate 306, provided at the end of the shaft 304, in the flow channel 311. As the valve 300 has a simple structure, as shown in FIGS. 10 and 11, it requires a small space for installation and can be repaired and maintained easily. In the valve 300, introduction of the leak-checking N₂ gas to the portion between the two O-rings 321 and 322, or between the two O-rings 323 and 324 through the N₂ gas inlet ports 315 and 317 in the sealing state facilitates checking as to whether sealing by the sealing plate 306 as the valve element is reliable.

In addition, the temperature control means such as the resistance heater 309 arranged at the hollow portion 306a in the sealing plate 306 serving as the valve element can prevent a by-product in the exhaust gas from being attached to the sealing plate 306. Therefore, in the valve 300, a decrease in sealing performance due to the attached substance, poor operation of the driving portion such as the shaft 304, or the like can be prevented, thus improving the reliability.

A practical application in which the valve 300 shown in FIGS. 10 and 11 is employed for switching between exhaust and cleaning in a trap device will be described.

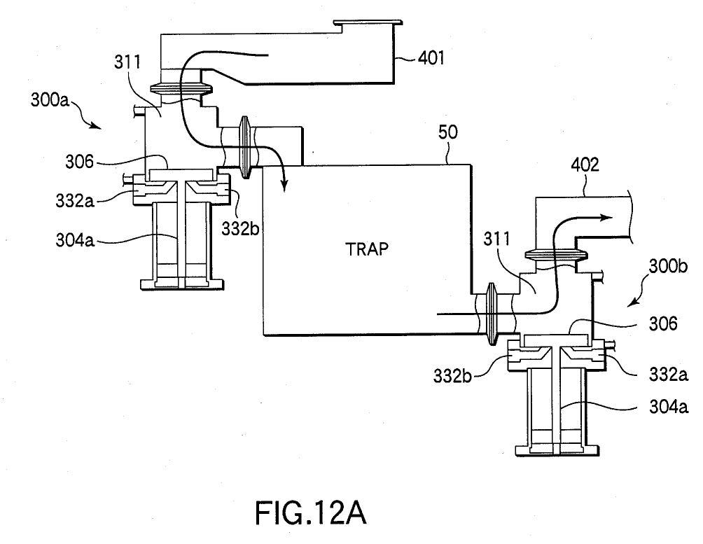

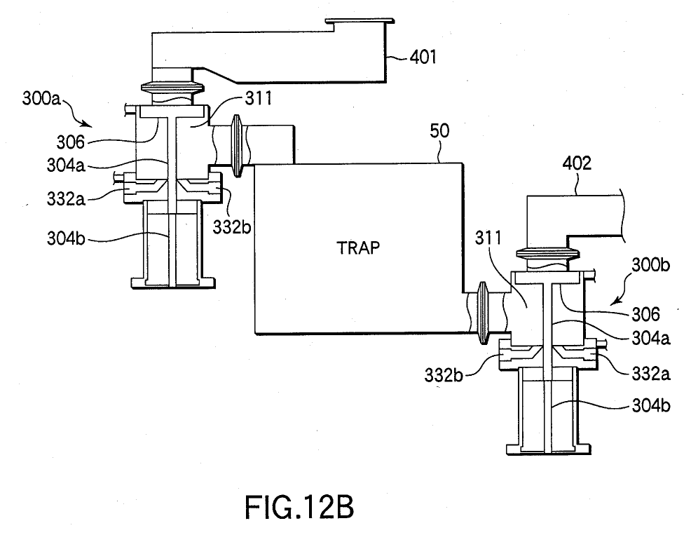

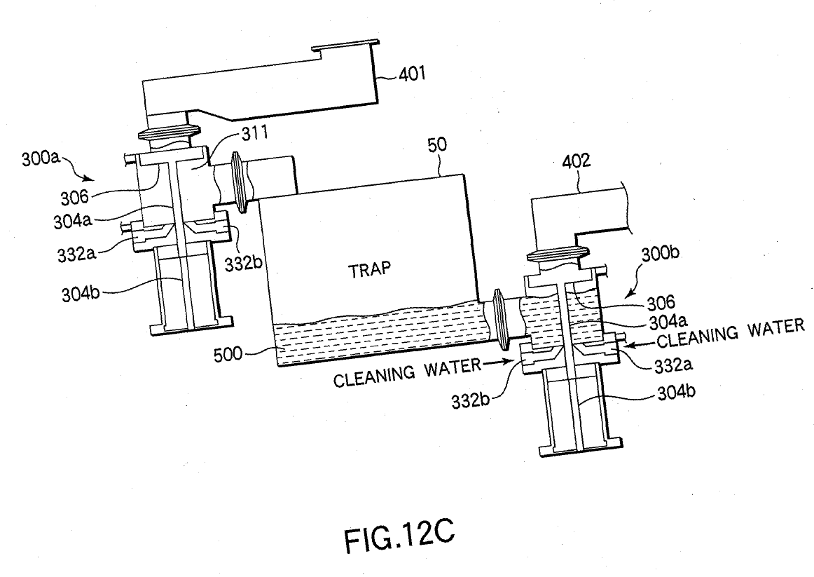

First, as shown in FIG. 12A, a pair of valves 300a and 300b each having the same arrangement as that shown in FIGS. 10 and 11 are disposed one on either side of a trap device (Trap) 50. The valve 300a is connected to the upper portion of the trap device 50, and the valve 300b is connected to the lower portion of the trap device 50 which is diagonal to the position where the valve 300a is connected. At this time, the valves 300a and 300b are arranged parallel to each other such that shafts 304 of air cylinders 303 drive in the vertical direction and that sealing plates 306 serving as valve elements are located at the upper ends of the shafts 304. The valve 300a is arranged such that a wall 313 (see FIG. 10) serving as a valve seat is lower than the upper end of the trap device 50. The valve 300b is arranged such that a wall 313 (see FIG. 10) serving as a valve seat is lower than the lower end of the trap device 50.

The upper valve 300a is connected to a pipe 401 through an in/out-flow portion 310a at the side opposite to the trap device 50. The pipe 401 is connected to the vacuum chamber of a CVD apparatus (not shown) or the like. The lower valve 300b is connected to a pipe 402 through an in/out-flow portion 310a at the side opposite to the trap device 50. The pipe 402 is connected to an exhaust pump, a detoxifying device, or the like (not shown).

FIG. 12A shows a state in the valve in a trap process. In the trap process, exhaust air from a vacuum chamber (not shown) is introduced to the trap device 50 to trap an unreacted process gas or a reaction product. In this state, second sealing surfaces 308 of the sealing plates 306 serving as the valve elements of the valves 300a and 300b have abutted against the corresponding walls 313. Accordingly, in the upper valve 300a, the exhaust gas is introduced into a flow channel 311 from the in/out-flow portion 310a formed at the upper portion and introduced to the trap device 50 through an in/out-flow portion 310b formed at the side portion. The exhaust gas discharged from the trap device 50 is introduced to a flow channel 311 through an in/out-flow portion 310b formed at the side portion of the lower valve 300b and discharged to the pipe 402 from an in/out-flow portion 310a formed at the upper portion.

FIG. 12B shows a state in which the exhaust flow channels are closed. More specifically, the shafts 304 of the valves 300a and 300b are driven to push up the sealing plates 306 from the state thereof shown in FIG. 12A, so first sealing surfaces 307 abut against corresponding walls 312. This seals the in/out-flow portions 310a of the valves 300a and 300b.

Subsequently, as shown in FIG. 12C, cleaning of the trap device 50 is started. A process liquid (e.g., cleaning water 500) for cleaning the trap device 50 is injected from in/out-flow channels 332a and 332b of the lower valve 300b, and introduced to the trap device 50 through the flow channel 311 and in/out-flow portion 310b.

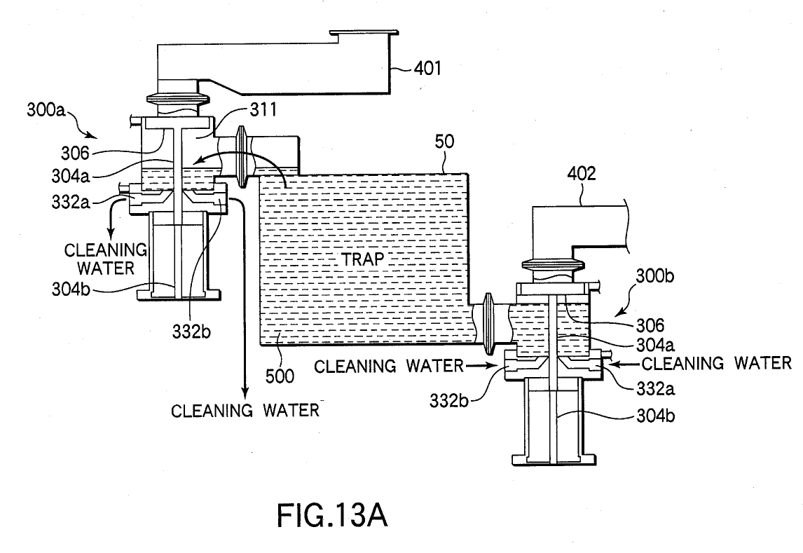

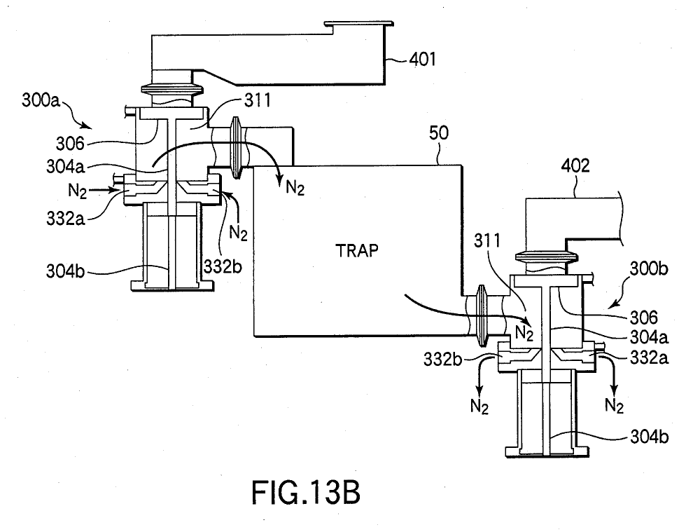

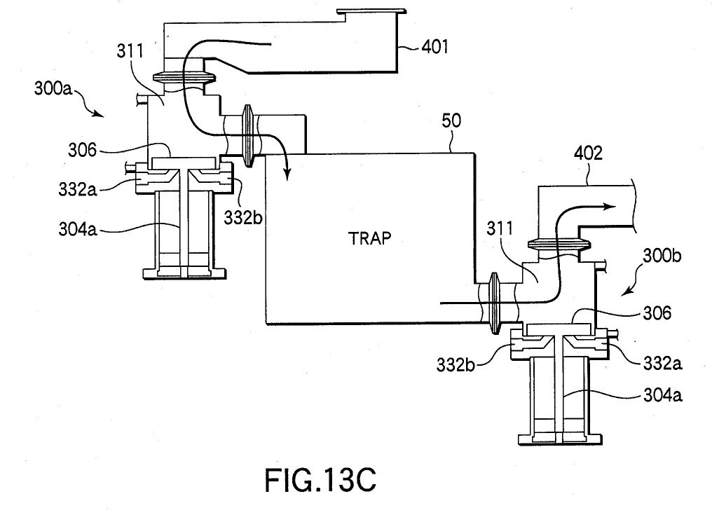

The liquid level of the cleaning water 500 in the trap device 50 rises gradually. Finally, after the cleaning water 500 fills the trap device 50, it overflows and flows into the valve 300a through the in/out-flow portion 310b of the upper valve 300a, as shown in FIG. 13A. The cleaning water 500 is then discharged from in/out-flow channels 332a and 332b of the valve 300a and supplied to a discharged liquid processing device (not shown). Cleaning of the trap device 50 by the overflow of the cleaning liquid is preferably done in, e.g., about 10 min to 20 min.

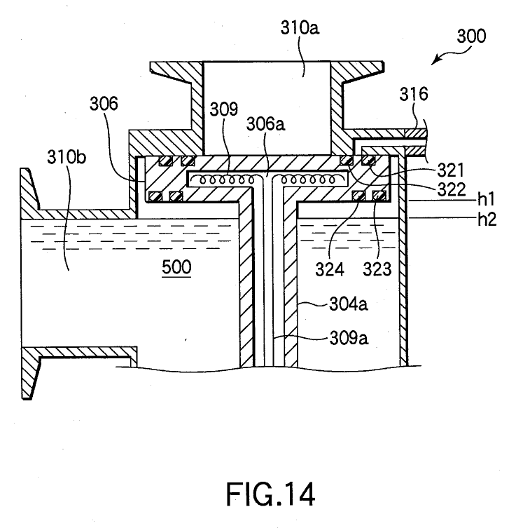

In the state (overflow cleaning) of FIG. 13A, the liquid level of the cleaning water in the flow channel 311 of the valve 300b does not reach the sealing plate 306. FIG. 14 shows the state of the liquid level of the cleaning liquid in the valve 300b during overflow cleaning. In the valve 300b of this embodiment, when the first sealing surface 307 of the sealing plate 306 abuts against the wall 312, a height h1 of the lower end of the sealing plate 306 is larger than a height h2 of the upper end (i.e., the inner wall surface) of the in/out-flow portion 310b projecting horizontally from a housing 302.

Two O-rings 321 and 322 disposed on the first sealing surface 307 hermetically close the portion between the sealing plate 306 and wall 312. Hence, as the cleaning liquid rises, air in the flow channel 311 flows into the trap device 50, but air above the upper end of the in/out-flow portion 310b can go nowhere but is confined in the space in the vicinity of the sealing plate 306 in the housing 2. Thus, the height h2 of the upper end of the in/out-flow portion 310b becomes the upper limit of the liquid level of the cleaning liquid, and the sealing plate 306 is not immersed in the cleaning liquid even during overflow cleaning. As described above, a resistance heater 309 is disposed in a hollow portion 306a in the sealing plate 306. Thus, for the safety reason, the sealing plate 306 should not be immersed in the cleaning liquid when the heater 309 is energized. According to this embodiment, as overflow cleaning can be performed without wetting the sealing plate 306 with the cleaning liquid, cleaning can be done while maintaining the resistance heater 309 heated. Therefore, the heating time of the sealing plate 306 by the resistance heater 309 can be reduced, thus shortening the cycle time of the trap process and cleaning process.

After the cleaning is ended in a predetermined time, supply of the cleaning water is stopped. During cleaning, the in/out-flow channels 332a and 332b of the valves 300a and 300b are open. When water supply is stopped and the connection of the in/out-flow channels 332a and 332b of the valve 300b is changed from the cleaning liquid source to the discharge liquid processing device (neither is shown), the cleaning water in the valve 300b and trap device 50 can be quickly discharged through the in/out-flow channels 332a and 332b of the lower valve 300b. At this time, if a gas such as N₂ is introduced from the in/out-flow channels 332a and 332b of the upper valve 300a, the cleaning water can be discharged from the in/out-flow channels 332a and 332b of the lower valve 300b effectively.

Subsequently, as shown in FIG. 13B, the trap device 50 is dried. In the drying process, a drying gas such as N₂ is introduced from the in/out-flow channels 332a and 332b of the upper valve 300a, allowed to pass through the trap device 50, and exhausted through the in/out-flow channels 332a and 332b of the lower valve 300b. This can dry the interior of the trap device 50. The duration of one drying operation by introduction of the drying gas is preferably, e.g., about 1 min to 30 min. The overflow cleaning process described above and the drying process can be combined as one cycle, and a plurality of cycles can be practiced repeatedly as needed.

Subsequently, the shafts 304 of the valves 300a and 300b are driven to move the sealing plates 306 downward, so the second sealing surfaces 308 of the sealing plates 306 abut against the corresponding walls 313. Thus, as shown in FIG. 13C, an exhaust gas channel from the vacuum chamber (not shown) communicates again, so the exhaust gas component can be trapped.

More specifically, the exhaust gas is introduced from the in/out-flow portion 310a of the upper valve 300a, allowed to pass through the flow channel 311, and introduced to the trap device 50 through the in/out-flow portion 310b. The exhaust gas discharged from the trap device 50 passes through the flow channel 311 of the valve 300b through the in/out-flow portion 310b of the lower valve 300b and is discharged from the in/out-flow portion 310a to the pipe 402.

By disposing the valves 300 (300a, 300b) of this embodiment to the exhaust gas channel one on either side of the trap device 50, the trap process of trapping the exhaust gas component by the trap device 50, the cleaning process of cleaning the interior of the trap device 50, and the drying process after cleaning can be switched easily.

As the valve 300 employs a double seal structure, it can also provide reliable hermeticity between the vacuum atmosphere and the atmospheric pressure atmosphere. In the double seal structure, the sealing state can be checked by introducing a purge gas between the seal members. Thus, the valve 300 has a high reliability.

The sealing plate 306 of the valve 300 comprises the resistance heater 309 as the temperature control means. This can prevent the reaction product in the exhaust gas from being attached. Due to the valve structure, the sealing plate 306 does not sink in the cleaning water even during cleaning. This allows cleaning of the trap device 50 while being heated by the resistance heater 309. Therefore, when operating the valve 300 again after cleaning the trap device 50, the heating time for the sealing plate 306 of the valve 300 can be saved, shortening the cycle time of the trap process and cleaning process. This enables a highly efficient trap process.

A plurality of trap devices 50 each provided with valves 300a and 300b one on either side thereof as shown in FIG. 12A may be disposed parallel to each other on the exhaust channel from the vacuum chamber, and introduction of the exhaust gas may be switched among the respective trap devices 50. This enables cleaning and trapping in the trap devices 50 in a parallel manner, so the trap devices can be maintained without stopping operation of the vacuum chamber.

Although the embodiments of the present invention have been described, the present invention is not limited to the above embodiments and various modifications can be made.

For example, in the above embodiments, the air cylinders 3a and 3b are used as the driving sources for driving the valve elements (sealing plates 6a and 6b). However, the driving sources are not limited to them, but mechanical driving using, e.g., a gear, or hydraulic driving may be employed. The driving system is not limited to one in which the air cylinders 3a and 3b drive the sealing plates 6a and 6b independently, but one driving system may drive a plurality of valve elements.

In the above embodiments, switching is performed between the flow channels (first and second flow channels) of two systems. Switching by means of the switching valve mechanism of the present invention can also be applied to switching among two systems or more, e.g., four systems.

Furthermore, in the trap device 100 shown in FIGS. 7 to 9, the valves 1 (1a and 1b) are respectively disposed at the inlet port and outlet port of the exhaust gas. Alternatively, the valve 1 may be disposed at only one port, and a switching means having another structure may be disposed at the other port.

The arrangement of the valves 1a and 1b is not limited to the one in which the valves 1a and 1b are arranged adjacent to the trap device 100 (as part of the trap device 100), as shown in FIGS. 7 to 9. Alternatively, the valves 1a and 1b may be arranged to be spaced apart from the trap device 100 and connected to each other with a pipe.

Furthermore, the positions to dispose the valves 1a and 1b are not limited to the exhaust system of the vacuum apparatus but can be anywhere on flow channels that require switching. For example, the valves 1a and 1b can be arranged on ordinary exhaust gas channels having no trap devices, and gas flow channels through which a plurality of types of gases that should not be mixed flow.

As shown in FIG. 3, the valve element in which the sealing plate 6 on which O-rings 21 to 24 are disposed is provided to the end of the shaft 4 is not limited to an application as a switching valve for the fluid flow channels of a plurality systems, but can be used as, e.g., a valve element such as an L-shaped valve for opening/closing the fluid flow channel of one system.

### INDUSTRIAL APPLICABILITY

The present invention is suitably used in a switching mechanism for an exhaust system in a vacuum process chamber which is used for a process such as film deposition in manufacturing various types of semiconductor devices.

1. A valve element for a valve for opening/closing a fluid flow channel, wherein
the valve element is provided to an end of a shaft which is driven in an axial direction, and
the valve element includes a first sealing surface configured to seal at least one fluid flow channel and a second sealing surface configured to seal a fluid flow channel different from the fluid flow channel, the first sealing surface and the second sealing surface being provided with seal portions, respectively.

2. The valve element according to claim 1, wherein the valve element forms a disk, and the first sealing surface is formed on a front surface of the disk and the second sealing surface is formed on a rear surface of the disk.

3. The valve element according to claim 1, wherein the seal portion includes a double seal structure.

4. The valve element according to claim 3, comprising
a gas introducing portion through which a gas is introduced to a gap inside the double seal structure in a sealing state, and
a measuring mechanism configured to measure one of a flow rate and a pressure of the gas which is to be introduced from the gas introducing portion.

5. The valve element according to claim 1, comprising a temperature control mechanism in the valve element.

6. A valve for opening/closing a fluid flow channel communicating with an in/out-flow portion through an opening formed therein, the in/out-flow portion being configured for a fluid to flow in and out therethrough, the valve comprising
a valve element provided to an end of a shaft which is driven in an axial direction, and including a first sealing surface configured to close the opening so as to seal the fluid flow channel and a second sealing surface configured to seal a fluid flow channel different from the fluid flow channel,
wherein the first sealing surface and the second sealing surface are provided with seal portions, respectively.

7. The valve according to claim 6, wherein the valve element forms a disk, and the first sealing surface is formed on one surface of the disk and the second sealing surface is formed on a rear surface of the disk.

8. The valve according to claim 6, wherein the seal portion includes a double seal structure.

9. The valve according to claim 8, comprising
a gas introducing portion through which a gas is introduced to a gap inside the double seal structure in a sealing state, and
a measuring mechanism configured to measure one of a flow rate and a pressure of the gas which is to be introduced from the gas introducing portion.

10. The valve according to claim 6, wherein an inner surface of a member which constitutes the fluid flow channel and against which at least the first sealing surface and the second sealing surface abut is coated with a fluoroplastic.

11. The valve according to claim 6, comprising a temperature control mechanism in the valve element.

12. A switching valve for switching between at least two fluid flow channels, the switching valve comprising:
an in/out-flow portion through which a fluid flows in or flows out;
a first fluid flow channel configured to communicate with the in/out-flow portion through a first opening formed in the in/out-flow portion; and
a second fluid flow channel configured to communicate with the in/out-flow portion through a second opening formed in the in/out-flow portion,
the switching valve further comprising:
a first valve element configured to close the first opening so as to seal the first fluid flow channel, and
a second valve element configured to close the second opening so as to seal the second fluid flow channel,
wherein the first valve element and the second valve element are provided to ends of shafts which are separately driven in axial directions.

13. The switching valve according to claim 12, wherein the first valve element includes a first sealing surface configured to seal the first fluid flow channel and a second sealing surface configured to seal a fluid flow channel different from the first fluid flow channel, the first sealing surface and the second sealing surface being provided with seal portions, respectively.

14. The switching valve according to claim 12, wherein the second valve element includes a first sealing surface configured to seal the second fluid flow channel and a second sealing surface configured to seal a fluid flow channel different from the second fluid flow channel, the first sealing surface and the second sealing surface being provided with seal portions, respectively.

15. The switching valve according to claim 13, wherein the first valve element forms a disk, and the first sealing surface is formed on one surface of the disk and the second sealing surface is formed on a rear surface of the disk.

16. The switching valve according to claim 14, wherein the second valve element forms a disk, and the first sealing surface is formed on one surface of the disk and the second sealing surface is formed on a rear surface of the disk.

17. The switching valve according to claim 13, wherein the seal portion includes a double seal structure.

18. The switching valve according to claim 14, wherein the seal portion includes a double seal structure.

19. The switching valve according to claim 17, comprising
a gas introducing portion through which a gas is introduced to a gap inside the double seal structure in a sealing state, and
a measuring mechanism configured to measure one of a flow rate and a pressure of the gas which is to be introduced from the gas introducing portion.

20. The switching valve according to claim 18, comprising
a gas introducing portion through which a gas is introduced to a gap inside the double seal structure in a sealing state, and
a measuring mechanism configured to measure one of a flow rate and a pressure of the gas which is to be introduced from the gas introducing portion.

21. The switching valve according to claim 13, wherein inner surfaces of members which respectively constitute the first fluid flow channel and the second fluid flow channel and against which at least the first sealing surface and the second sealing surface abut respectively are coated with a fluoroplastic.

22. The switching valve according to claim 14, wherein inner surfaces of members which respectively constitute the first fluid flow channel and the second fluid flow channel and against which at least the first sealing surface and the second sealing surface abut are coated with a fluoroplastic.

23. The switching valve according to claim 12, wherein the first fluid flow channel and the second fluid flow channel form part of an exhaust channel through which an exhaust gas from a vacuum process chamber is discharged, and communicate with a trap device configured to trap a substance in the exhaust gas.

24. The switching valve according to claim 12, comprising a temperature control mechanism in the first valve element.

25. The switching valve according to claim 12, comprising a temperature control mechanism in the second valve element.

26. A trap device for trapping a substance in an exhaust gas, to be provided midway along an exhaust channel including an in/out-flow portion through which the exhaust gas from a vacuum process chamber flows in and out, a first exhaust gas flow channel being configured to communicate with the in/out-flow portion through a first opening formed in the in/out-flow portion, and a second exhaust gas flow channel being configured to communicate with the in/out-flow portion through a second opening formed in aid in/out-flow portion, the trap device comprising:
a switching mechanism configured to alternately switch inflow of the exhaust gas into a plurality of trap chambers and comprising a switching valve including a first valve element configured to close the first opening so as to seal the first exhaust gas flow channel, and a second valve element configured to close the second opening so as to seal the second exhaust gas flow channel, the first valve element and the second valve element being provided to ends of shafts which are separately driven in axial directions.

27. The trap device according to claim 26, comprising a temperature control mechanism in the first valve element and the second valve element.

28. The trap device according to claim 26, wherein the vacuum process chamber comprises a vacuum chamber for a film deposition apparatus configured to form a film on a target body.
